(19) United States
(12) Patent Application Publication
(10) Pub. No.: US 2026/0038261 A1
(43) Pub. Date: Feb. 5, 2026

(54) METHOD AND SYSTEM FOR PROVIDING ASSISTANCE TO A USER DURING INSTALLING, MAINTAINING, AND/OR COMMISSIONING OF AN ELEVATOR SYSTEM

(71) Applicant: KONE Corporation, Helsinki (FI)

(72) Inventors: Mika Kemppainen, Helsinki (FI); Mika Sundqvist, Helsinki (FI)

(73) Assignee: KONE Corporation, Helsinki (FI)

(21) Appl. No.: 19/355,774

(22) Filed: Oct. 10, 2025

Related U.S. Application Data
(63) Continuation of application No. PCT/FI2023/050205, filed on Apr. 12, 2023.

(51) Int. Cl. G06V 20/20; B66B 19/00; G09B 5/02

(52) U.S. Cl. CPC G06V 20/20; B66B 19/00; G09B 5/02

(57) ABSTRACT

A method and a system provide assistance to a user during installing, maintaining, and/or commissioning of an elevator system. The method includes creating a digital representation, such as a digital twin, of the elevator system and its physical environment, such as the current or the future physical environment. The method also includes configuring a display device, which includes or is connected to an optical sensor, such as a digital camera, to run the digital representation, sensing, by the optical sensor, a portion of the physical environment, and comparing the portion to a corresponding portion of the digital representation, the portion being arranged to be visible on the display device.

### TECHNICAL FIELD

The present invention relates in general to elevator systems. In particular, however, not exclusively, the present invention concerns methods and systems for assisting a user, such as a maintenance person, during installing, maintaining, and/or commissioning of an elevator system.

### BACKGROUND

During installation of an elevator system, such as its various components and devices, manual labour is required from a service or maintenance person. Typically, tasks such as manual tuning with special tools are being performed. These require special skills from the maintenance person and can, in many cases, only be performed satisfactorily by an experienced person.

The installation procedure, thus, has some drawbacks. For example, installation and maintenance quality is fully dependent on who (person) is doing it. All work is fully manual and due to that reason quality of installation and maintenance varies a lot. There is thus need to develop methods and systems in order to increase the quality of the elevator system installations.

### SUMMARY

An objective of the present invention is to provide a method and a system for providing assistance to a user during installing, maintaining, and/or commissioning of an elevator system. Another objective of the present invention is that the method and the system provide accurate feedback to a maintenance or service person during elevator installation, maintenance, and/or commissioning related to the elevator object being currently under work.

The objectives of the invention are reached by a method and a system for providing assistance to a user during installing, maintaining, and/or commissioning of an elevator system as defined by the respective independent claims.

According to a first aspect, a method for providing assistance to a user during installing, maintaining, and/or commissioning of an elevator system is provided.

The method comprises creating a digital representation, such as a digital twin, of the elevator system and its physical environment, such as the current or the future physical environment. Said creating comprises obtaining or generating a first digital model of the physical environment, obtaining or generating a number of reference digital models of elevator objects of the elevator system, and integrating the first digital model and the number of reference digital models to create the digital representation.

The method also comprises configuring a display device, which comprises or is connected to an optical sensor, such as a digital camera, to run the digital representation. The display device may, preferably, be augmented reality glasses, including a digital camera integrated thereto, being wearable by the user.

The method further comprises sensing, by the optical sensor, such as a digital camera, a portion of the physical environment, and comparing said portion to a corresponding portion of the digital representation, wherein said portion is arranged to be visible on the display device.

In a non-limiting example, the obtaining of the first digital model of the physical environment may include getting a ready-made digital model of the physical environment, such as including dimensions, such as related to walls, top and bottom, of an elevator shaft and/or of an elevator machine room.

In another non-limiting example, the generating a first digital model of the physical environment may comprise performing a site survey with laser measures and/or by photographing to obtain a 3D model.

Furthermore, the method may comprise recognizing an elevator object, such as a component or a device, in the portion the physical environment.

The elevator object, as referred to herein, may mean components or devices in the elevator shaft, the elevator machine room. On the other hand, the elevator object may be the elevator car, or devices in connection to the elevator car. Thus, as can be understood, the elevator object may be a physical object related to or comprised in the elevator system.

In various embodiments, the method may comprise comparing the recognized object to a corresponding object in the digital representation. For example, the recognized object may be a safety device inside the elevator shaft. The safety device is recognized, such as by pattern or shape recognition algorithm or the like, or even by the user providing an input to the display device confirming which elevator object is being sensed by the optical sensor.

In many embodiments, the method may comprise tracking the recognized object. Thus, even if the user changes his/her position, the recognized object is being evaluated by the display device, as long as it remains in the portion sensed by the optical sensor.

The method may further comprise providing instructions and/or information related to the recognized object to the user via the display device. For example, the instructions and/or information may include an acceptable tolerance for said elevator object. In another example, the instructions and/or information may include one or more values of operational parameters for said elevator object, such as for tuning the operation of the elevator device. On the other hand, the instructions may be a notification or a corrective action instruction.

In preferable embodiments, the providing comprises superimposing said instructions and/or information on the portion being visible on the display device, such as utilizing an augmented reality technology. Thus, the user may see on the display device the actual elevator object and, at the same time, there is instructions and/or information being shown on the display device related the recognized elevator object.

In various embodiments, the method may comprise detecting a difference between said portion and the corresponding portion as a result of the comparison, if said portion differs from the corresponding portion.

Furthermore, the providing of instructions and/or information comprises providing a notification or a corrective action instruction based on to the detection of the difference to the display device.

According to a second aspect, a system for providing assistance to a user during installing, maintaining, and/or commissioning of an elevator system is provided.

The system comprises a display device, which comprises or is connected to an optical sensor, and a data processing system, wherein the display device is arranged to be in a communication connection with the data processing system.

The data processing system is configured to store a digital representation, such as a digital twin, of the elevator system and its physical environment, such as the current or the future physical environment, including at least, preferably as integrated, a first digital model of the physical environment and a number of reference digital models of elevator objects of the elevator system.

The display device is configured to run the digital representation, sense, by the optical sensor, a portion of the physical environment, and compare said portion to a corresponding portion of the digital representation, wherein said portion is arranged to be visible on the display device.

The running of the digital representation may require first obtaining or even creating the digital representation (such as using laser scanning and/or photographic means), as is contemplated hereinbefore.

In preferable embodiments, the display device may be augmented reality glasses or other “smart glasses”. These glasses have a display on the lenses and may, preferably, comprise an integrated digital camera pointing away from the user.

In some other embodiments, the display device may be a portable computer, such as a tablet computer or a smart phone or the like.

In yet another embodiments, the display device may be only connected to a separate optical sensor, such as to a digital camera or cameras.

In various embodiments, the data processing system may be a local processing system of the elevator system. The display device may be connected thereto via an internal wireless or wired network of the elevator system.

In other embodiments, the data processing system may be a cloud-based processing system or other such remote server system.

Furthermore, the system may be configured to recognize an elevator object, such as a component or a device, in the portion the physical environment.

In preferable embodiments, the system may be configured to compare the recognized object to a corresponding object in the digital representation. In addition, the system may be configured to track the recognized object.

Still further, the system may be configured to provide instructions and/or information related to the recognized object to the user via the display device. In some embodiments, said provision of instructions and/or information may comprise superimposing said instructions and/or information on the portion being shown on the display device, such as utilizing an augmented reality technology.

The system may also be configured to detect a difference between said portion and the corresponding portion as a result of the comparison, if said portion differs from the corresponding portion. Said provision of instructions and/or information may comprise providing a notification or a corrective action instruction based on to the detection of the difference to the display device. In various embodiments, the instructions and/or information may include an acceptable tolerance for said elevator object. In various embodiments, alternatively or in addition, the instructions and/or information may include one or more values of operational parameters for said elevator object.

The present invention provides a method and a system for providing assistance to a user during installing, maintaining, and/or commissioning of an elevator system. The present invention provides advantages over known solutions in that the installer and maintenance person or technician, when operating commissioning with elevator, is given accurate live guidance to person during elevator installation and maintenance work by comparing existing real installation to ideal setup utilizing digital representation including the digital models or “virtual reference models”. The use of the method and system reduces errors during installation and maintenance operations by giving clear, live instructions to persons while they are doing installation and maintenance work. The system also increases availability due there being less need for manual work during the elevator operations which may be measured by reduced customer call-out-rate for unplanned maintenance. Thus, labour time needed for calibration and tuning after installation and during regular maintenance is reduced.

In various embodiments, the need for installation and maintenance personnel competence and experience and later phase checking and re-tuning is reduced. At the same time, quality is improved by having standard installation and maintenance within guided tolerance measures by comparing the digital representation with the actual elevator system installation and physical environment.

Various other advantages will become clear to a skilled person based on the following detailed description.

The expression “a number of” herein refers to any positive integer starting from one, that is being one, two, or three, and so on.

The expression “a plurality of” may refer to any positive integer starting from two, being two, at least two, three, at least three, etc.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

Some embodiments of the invention are illustrated by way of example, and not by way of limitation, in the figures of the accompanying drawings.

FIG. 1 illustrates schematically a system in accordance with an embodiment of the present invention.

FIGS. 2A and 2B illustrate schematically display devices in accordance with some embodiments of the present invention.

FIG. 3 illustrates schematically a display device in accordance with some embodiments of the present invention.

FIG. 4 shows a flow diagram of a method in accordance with an embodiment of the present invention.

### DETAILED DESCRIPTION

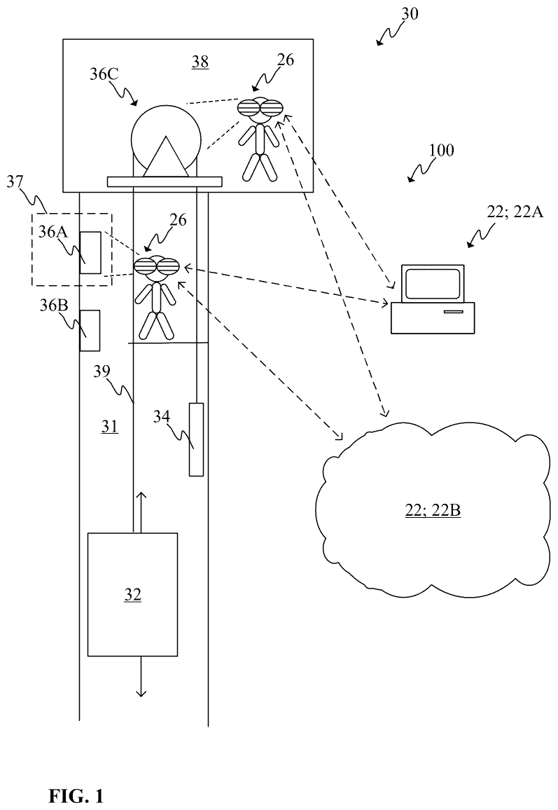

FIG. 1 illustrates schematically a system 100 for providing assistance to a user during installing, maintaining, and/or commissioning of an elevator system 30. The system 100 comprising a display device 26, which comprises or is connected to an optical sensor 28, and, of course, a display screen 26 being able display data/information/instructions etc, that is, it comprises a display.

The system 100 also comprises a data processing system 22, such as a data server or the like computer system. Furthermore, the display device 26 is arranged to be in a communication connection with the data processing system 22.

The data processing system 22 is configured to store a digital representation, such as a digital twin, of the elevator system 30 and its physical environment, such as the current or the future physical environment, including at least, preferably as integrated, a first digital model of the physical environment and a number of reference digital models of elevator objects 36A-36C of the elevator system 30.

Furthermore, the display device 26 is configured to run the digital representation, sense, by the optical sensor 28, a portion 37 of the physical environment, and compare said portion 37 to a corresponding portion of the digital representation, wherein said portion 37 is arranged to be visible on the display device.

The current physical environment refers to cases in which the elevator system has already been installed to its environment, and thereby the system 100 may be used, for example, to replace, repair or maintain/service elevator objects 36A-36C.

The future physical environment refers to cases in which there is a site to which the elevator system 30 is intended to be installed. Thus, a digital model of the physical environment may be produced prior to installing any of the objects 36A-36C of the elevator system 30 into its intended physical environment.

Regarding the data processing system 22, it may be a local processing system 22A of the elevator system 30, or a cloud-based processing system 22B or other remote (relative to the elevator system 30) server system.

The system 100 may be configured to recognize an elevator object 36A-36C, such as a component or a device of the elevator system 30, in the portion 37 the physical environment. This may be performed by utilizing a pattern and/or a shape recognition algorithm. Alternatively, the object 36A-36C may be recognized by utilizing an identification element or device, such as a barcode, a QR code, or a radio frequency identification (RFID) tag, or the like device based on a near field communication. The recognition may be performed substantially automatically by the optical sensor 28, or the user may provide recognition input to the system 100, such as via a user interface of the display device 26, for example, a touch display or an eye tracking technology.

The recognition of the object 36A-36C, preferably, includes identifying from the digital representation a corresponding portion, such as including a corresponding object, being, for example, a device or a component of the elevator system 30.

In various embodiments, the system 100 may be configured to compare the recognized object 36A-36C to a corresponding object in the digital representation. In addition, the system 100 may be configured to track the recognized object 36A-36C. Thus, the object 36A-36C under work may easily studied by the user even if he/she moves.

In various embodiments, the system 100 may be configured to utilize one or, preferably, a plurality of anchor points. Furthermore, the anchor point(s) may be utilized to compare the digital representation, and the elevator system and its physical environment at the anchor point(s).

The anchor point(s) may thus be utilized in synchronization or positioning of the digital representation relative to the current location of the physical environment.

An anchor point may be indicated by, for example, a 2D marker, which can basically be any visible symbol that can be sensed by the optical sensor 28. On the other hand, the anchor point may be detected by, for example, a short-range wireless communication device, such as being an RFID tag or the like and being thus readable by an RFID reader.

In some embodiments, the 2D marker may, thus, be detected by the optical sensor 28 of the display device 26. Based on the detection of the anchor point(s), the display device 26 can be provided relevant information about the corresponding portion of digital representation.

According to a non-limiting example, the anchor point may be arranged on the bottom, or pit, of an elevator shaft. The anchor point, when being detected or read by the optical sensor 28, provide information about its location and, thereby may be linked to the corresponding portion of the digital representation.

Furthermore, optionally, the anchor point(s) may be utilized to update or synchronize the digital representation to be in conformity with the physical environment, if differences are detected between the digital representation and the physical environment.

In various embodiments, the system 100 may be configured to operate in an operation mode, such as in a first operation mode, in which the display device 26 shows only relevant pieces of information on the display thereof based on the current location and/or word flow phase, for instance.

In the first operation mode, the relevant information may be manually chosen by the user or may even be automatically chosen by the display device 26 based on information about the location and/or next steps in the work flow of the user. For example, if the user is installing a device or component related to a certain sub-system or sub-configuration, only relevant information to that sub-system or sub-configuration may be shown.

In some embodiments, the relevant information is determined based on previous or current anchor point. The relevant information may thus be related to component or device concerning the next, future anchor point. Thus, it is avoided that the display device shows too much and/or futile or unnecessary information which do not relate to the next, future anchor point.

In a non-limiting example, the previous or current anchor point may relate to a first piece of a guide rail. The next anchor point would then be a second piece of guide rail that is to be installed after the first piece and to be in contact with the first piece. Thus, the display device 26 only shows, in the first operation mode, relevant information regarding the second piece of guide rail.

In various embodiments, the first operation mode differs from a general operation mode of the system 100. In the general operation mode, the display device 26 shows all or most of the information that is available from the digital representation regarding the corresponding portion of the digital representation with respect to the physical environment. Thus, the information being provided to the display device 26 and shown on the display thereof in the general operation mode depends primarily on the current portion of the environment towards which the optical sensor 28 is being pointed at.

FIG. 1 further illustrates an elevator shaft 31 along which an elevator car 32 is movable. The elevator car 32 may be moved by using, for example, an elevator motor in connection with a hoisting rope 39. The hoisting rope 39 may comprise, for example, steel or carbon fibres. The term hoisting rope does not limit the form of the element anyhow. For example, the hoisting rope 39 may be implemented as a rope, a belt, or a track in ropeless or rope-free elevators. On the other hand, the elevator car 32 may be moved by hydraulic means or by a linear motor.

The elevator object 36A-36C is not limited to a single elevator component or device. The elevator object, such as object 36A and 36B, may reside in the elevator shaft 31. Alternatively, the elevator object, such as 36C, may reside in the machine room 38 or the like, if any, of the elevator system 30.

The elevator object 36A-36C may, thus, be a simple support element, for instance. On the other hand, the elevator object 36A-36C may be an electromechanical device. For example, the elevator object 36A-36C may be safety switch or other safety device, an electric actuator, an electric motor, a battery, etc. As known by the skilled person in the art, a typical elevator system 100 is made of hundreds, even thousands of components, devices and sub-systems, all of which need to be correctly installed and configured. In accordance with various embodiments of the present invention, the digital representation, or digital twin, includes at least one, some, most or even all of these components, devices and sub-systems. Thus, the user can work on various elevator objects 36A-36C and conveniently get information and/or instruction related to them directly to the display device 26.

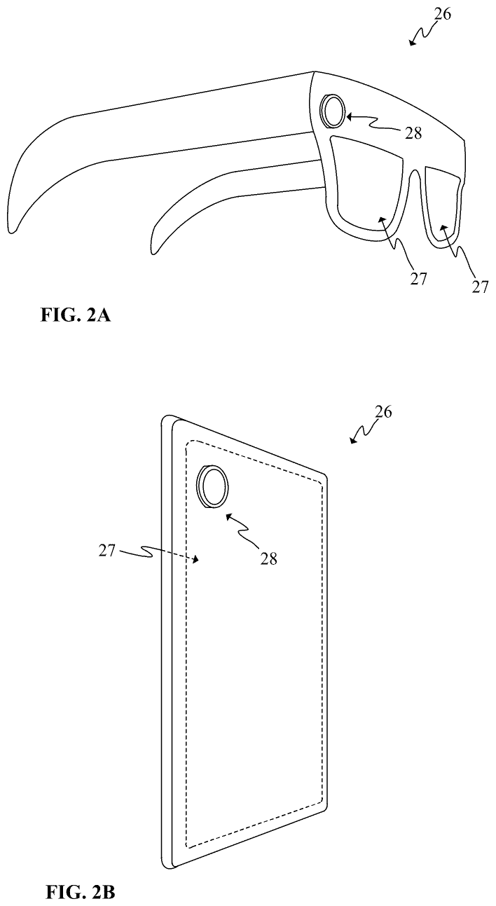

FIGS. 2A and 2B illustrate schematically display devices 26 in accordance with some embodiments of the present invention. FIG. 2A illustrates that the display device 26 are augmented reality glasses. FIG. 2B illustrates that the display device 26 is a portable computer.

The system 100 may, in preferable embodiments, configured to provide instructions and/or information related to the recognized object 36A-36C to the user via the display device 26.

The augmented reality glasses provide especially easy way for the user to look towards the portion 37 at the same time as he/she words on the object 36A-36C. The user thus immediately and conveniently sees any instructions and/or information related to the recognized object 36A-36C. Alternatively, the user may point the optical sensor 28 of the portable computer, such as tablet computer or a smart phone, towards the portion 37, but then study and work on the object 36A-36C by not looking via the display device 26. The user may then, from time to time, have a glance at the display device 26 to see whether there are any instructions and/or information related to the recognized object 36A-36C being displayed.

Alternatively, the display device 26 only comprises, as integrated thereto, a display, however, is further connected to an optical sensor 28, such as a separate digital camera. The combination of these two devices may also be utilized to perform the functions of the system 100.

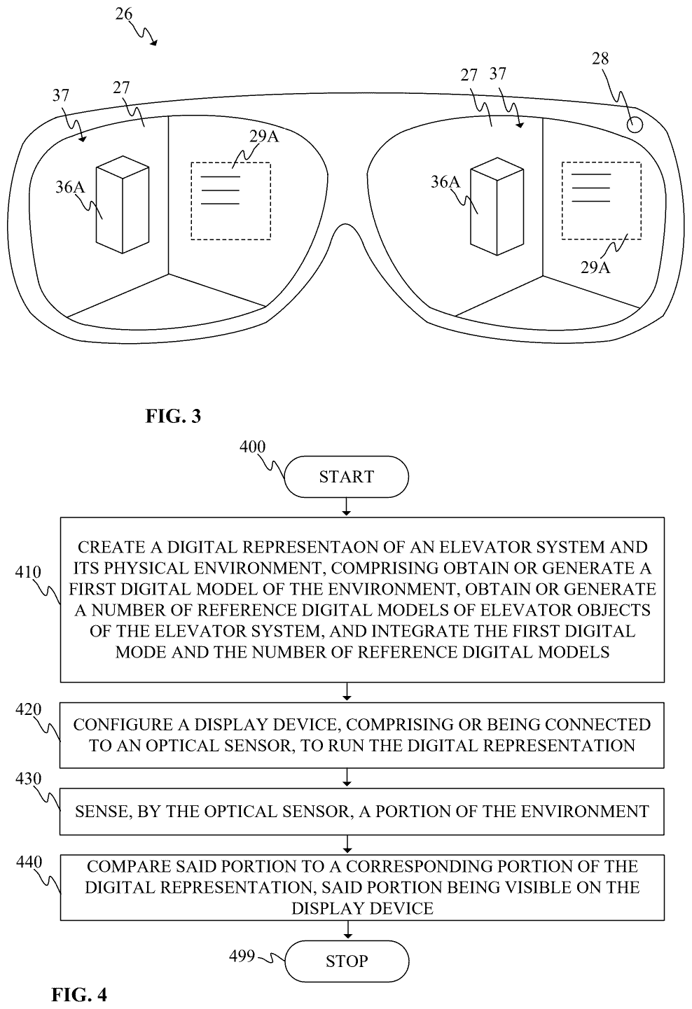

FIG. 3 illustrates schematically a display device 26 in accordance with some embodiments of the present invention. For example, the device 26 in FIG. 3 may be augmented reality glasses.

Thus, said provision of instructions and/or information preferably comprises superimposing the instructions and/or information 29A on the portion 37 being shown on the display device 26, that is, related to the recognized object 36A.

In various embodiments, the system 100 may be configured to detect a difference between said portion 37, or the recognized object 36A-36C, and the corresponding portion, or the corresponding object, as a result of the comparison, if said portion 37 differs from the corresponding portion. In addition, said provision of the instructions and/or information may comprise providing a notification or a corrective action instruction based on to the detection of the difference to the display device 26.

Regarding the instructions and/or information they may include, for example, an acceptable tolerance for said elevator object 36A-36C. The user may, thus, get immediate feedback whether the object 36A-36C was installed correctly in view of the acceptable tolerances.

On the other hand, the instructions and/or information may include one or more values of operational parameters for said elevator object 36A-36C. Thus, the instructions and/or information do not necessarily relate so much to physical parameters but, for example, to control or tuning parameters of an electrical device. Thus, the user can conveniently set correct control parameters since they are being displayed on the display device 26 at the same time the user is working on the object 36A-36C.

FIG. 4 shows a flow diagram of a method in accordance with an embodiment of the present invention.

Item or method step 400 refers to a start-up phase of the method. Suitable equipment, components, devices, and sub-systems are obtained and systems assembled and configured for operation.

Item or method step 410 refers to creating a digital representation, such as a digital twin, of the elevator system and its physical environment, such as the current or the future physical environment, said creating comprising obtaining or generating a first digital model of the physical environment, obtaining or generating a number of reference digital models of elevator objects of the elevator system, and integrating the first digital model and the number of reference digital models to create the digital representation.

Item or method step 420 refers to configuring a display device 26, which comprises or is connected to an optical sensor 28, such as a digital camera, to run the digital representation.

Item or method step 430 refers to sensing, by the optical sensor 28, a portion 37 of the physical environment.

Item or method step 440 refers to comparing said portion 37 to a corresponding portion of the digital representation, wherein said portion 37 is arranged to be visible on the display device 26.

Method execution may be stopped at item or method step 499.

The method may further comprise recognizing an elevator object 36A-36C, such as a component or a device, in the portion 37 the physical environment.

In some embodiments, the method may comprise detecting an anchor point or points by the display device 26, such as after or during item or method step 430. Still further, the anchor point may be utilized to limit the information obtained from the digital representation and being shown on the display device 26 to relevant information regarding the current anchor point or a future anchor point.

In various embodiments, the method may comprise comparing the recognized object 36A-36C to a corresponding object in the digital representation.

Still further, the method may comprise tracking the recognized object 36A-36C.

The method may also comprise providing instructions and/or information 29A related to the recognized object 36A-36C to the user via the display device 26. Furthermore, the providing may comprise superimposing instructions and/or information 29A on the portion 37 being visible on the display device 26, such as utilizing an augmented reality technology.

In various embodiments, the method may comprise detecting a difference between said portion 37 and the corresponding portion as a result of the comparison, if said portion 37 differs, relative to structure, position, operational parameters, etc thereof, from the corresponding portion. In addition, said providing of instructions and/or information 29A may comprise providing a notification or a corrective action instruction based on to the detection of the difference to the display device 26.

As contemplated hereinbefore, the instructions and/or information 29A may include an acceptable tolerance for said elevator object. Alternatively or in addition, the instructions and/or information 29A may include one or more values of operational parameters for said elevator object 36A-36C.

The scope of the present invention is determined by the appended claims together with the equivalents thereof. A person skilled in the art will appreciate the fact that the disclosed embodiments were constructed for illustrative purposes only, and other arrangements applying many of the above principles could be readily prepared to best suit each potential use scenario.

1. A method for providing assistance to a user during installing,
maintaining, and/or commissioning of an elevator system, the method comprising:
creating a digital representation, such as a digital twin, of the elevator system and its physical environment, such as the current or the future physical environment, said creating comprising:
obtaining or generating a first digital model of the physical environment,
obtaining or generating a number of reference digital models of elevator objects of the elevator system, and
integrating the first digital model and the number of reference digital models to create the digital representation;
configuring a display device, which comprises or is connected to an optical sensor, such as a digital camera, to run the digital representation;
sensing, by the optical sensor, a portion of the physical environment, and
comparing said portion to a corresponding portion of the digital representation, wherein said portion is arranged to be visible on the display device.

2. The method of claim 1, comprising recognizing an elevator object, such as a component or a device, in the portion the physical environment.

3. The method of claim 1, comprising comparing the recognized object to a corresponding object in the digital representation.

4. The method of claim 2, comprising tracking the recognized object.

5. The method of claim 1, comprising providing instructions and/or information related to the recognized object to the user via the display device.

6. The method of claim 5, wherein the providing comprises superimposing instructions and/or information on the portion being visible on the display device, such as utilizing an augmented reality technology.

7. The method of claim 1, comprising detecting a difference between said portion and the corresponding portion as a result of the comparison, if said portion differs from the corresponding portion.

8. The method of claim 7, wherein the providing of instructions and/or information comprises providing a notification or a corrective action instruction based on to the detection of the difference to the display device.

9. The method of claim 2, wherein the instructions and/or information include an acceptable tolerance for said elevator object.

10. The method of claim 2, wherein the instructions and/or information include one or more values of operational parameters for said elevator object.

11. A system for providing assistance to a user during installing, maintaining, and/or commissioning of an elevator system, the system-comprising:
a display device, which comprises or is connected to an optical sensor, and
a data processing system;
wherein the display device is arranged to be in a communication connection with the data processing system, wherein the data processing system is configured to store a digital representation, such as a digital twin, of the elevator system and its physical environment, such as the current or the future physical environment, including at least, preferably as integrated, a first digital model of the physical environment and a number of reference digital models of elevator objects of the elevator system, and
wherein the display device is configured to:
run the digital representation,
sense, by the optical sensor, a portion of the physical environment, and
compare said portion to a corresponding portion of the digital representation, wherein the portion is arranged to be visible on the display device.

12. The system of claim 11, wherein the display device are augmented reality glasses.

13. The system of claim 11, wherein the display device is a portable computer.

14. The system of claim 11, wherein the data processing system is a local processing system of the elevator system.

15. The system of claim 11, wherein the data processing system is a cloud-based processing system.

16. The system of claim 11, configured to recognize an elevator object, such as a component or a device, in the portion the physical environment.

17. The system of claim 11, configured to compare the recognized object to a corresponding object in the digital representation.

18. The system of claim 17, configured to track the recognized object.

19. The system of claim 17, configured to provide instructions and/or information related to the recognized object to the user via the display device.

20. The system of claim 19, wherein said provision of instructions and/or information comprises superimposing said instructions and/or information on the portion being shown on the display device, such as utilizing an augmented reality technology.

21. The system of claim 11, configured to detect a difference between said portion and the corresponding portion as a result of the comparison, if said portion differs from the corresponding portion.

22. The system of claim 21, wherein said provision of instructions and/or information comprises providing a notification or a corrective action instruction based on to the detection of the difference to the display device.

23. The system of claim 19, wherein the instructions and/or information include an acceptable tolerance for said elevator object.

24. The system of claim 19, wherein the instructions and/or information include one or more values of operational parameters for said elevator object.
